(19) United States
(12) Patent Application Publication
(10) Pub. No.: US 2009/0006713 A1
(43) Pub. Date: Jan. 1, 2009

(54) DYNAMIC VIRTUALIZED VOLUME

(76) Inventors: Matthew I. Royer, DuPont, WA (US); Daniel W. Brunton, Lakewood, WA (US); Patricia A. Roberts, Steilacoom, WA (US)

Correspondence Address: INTEL CORPORATION;c/o INTELLEVATE, LLC, P.O. BOX 52050, MINNEAPOLIS, MN, 55402, US

(21) Appl. No.: 11/768,289

(22) Filed: Jun. 26, 2007

(51) Int. Cl. G06F 12/02

(52) U.S. Cl. 711/6; 711/E12.016

(57) ABSTRACT

Providing a virtualized volume to a client and virtualized files on the virtualized volume by emulating a disk, emulating a file system, and storing an file corresponding to the each virtualized file on at least one of a plurality of volume layers.

### BACKGROUND

Some platforms may exist as virtualized machines or virtualized platforms. Virtualization is a technique that enables a processor based host machine with support for virtualization in hardware and software, or in some cases, in software only, to present an abstraction of the host, such that the underlying hardware of the host machine appears as one or more independently operating virtual machines. Each virtual machine may therefore function as a self-contained platform. Often, virtualization technology is used to allow multiple guest operating systems and/or other guest software to coexist and execute apparently simultaneously and apparently independently on multiple virtual machines while actually physically executing on the same hardware platform. A virtual machine may mimic the hardware of the host machine or alternatively present a different hardware abstraction altogether.

Virtualization systems provide guest software operating in a virtual machine with a set of resources (e.g., processors, memory, IO devices) and may map some or all of the components of a physical host machine into the virtual machine, or create fully virtual components. The virtualization system may thus be said to provide a virtual bare machine interface to guest software. In some embodiments, virtualization systems may include a virtual machine monitor (VMM) which controls the host machine. The VMM provides guest software operating in a virtual machine (VM) with a set of resources such as processors, memory, and IO devices. The VMM may map some or all of the components of a physical host machine into the virtual machine, and may create fully virtual components, emulated in software in the VMM, which are included in the virtual machine (e.g., virtual IO devices). The VMM uses facilities in a hardware virtualization architecture to provide services to a virtual machine and to provide protection from and between multiple virtual machines executing on the host machine. Generally, the memory space in which the VMM operates is a part of host physical memory that is not accessible to any of the virtual machines that are serviced by the VMM.

When a large number of clients such as computers in an enterprise wide network all access a similar set of files, a great deal of redundant disk storage is used. For example, in an enterprise where most computing is done with an SQL Server database on Microsoft Windows®, typically each computer in the enterprise network replicates the Windows operating system code, the SQL server code, and therefore a large cost is incurred in disk space to store these redundant and commonly shared items. Moreover, any updates to the operating system or database server must be performed by updating all the computers in the network individually, a practice prone to error and dependent on users to either update computers manually or to keep their computers running during automatic updates.

### BRIEF DESCRIPTION OF THE DRAWINGS

FIG. 1 depicts a high level block diagram of one embodiment.

FIG. 2 depicts a user level view and its underlying implementation in one embodiment.

FIG. 3 depicts the organization of a set of virtual volume layers into dynamic virtual volumes for different client systems in an embodiment.

FIG. 4 depicts the processing in creating a virtual volume in an embodiment

FIG. 5 depicts processing of a read request targeted at a virtual volume in an embodiment.

FIG. 6 depicts processing of a write request targeted at a virtual volume in an embodiment.

### DETAILED DESCRIPTION

A virtual view of a normal disk or logical unit number slice may be provided to a program executing on a virtualized or a physical processor based platform.

In the virtualized case, a guest executing on a virtualized platform may make disk accesses such as for example by calling low level disk access routines, in the case of the guest Operating System (OS), or making an OS call for application level guests. These calls may be intercepted or redirected via the VMM to a virtual volume emulation engine (VEE) that may then provide data to the client by emulating a file system and an underlying disk or Logical Unit Number slice (LUN slice). This then allows the virtual VEE to redirect data from multiple disk sources to the guest and make it appear to the guest as if the data is being provided by a single disk or LUN slice, thereby providing a virtualized volume to the virtualized guest client.

In the case of non-virtualized system, a VEE may replace the low level disk access drivers used to access disk in a normal processor based platform and similarly the VEE may then redirect data from multiple disk sources to a program executing on the non-virtualized processor based system and make it appear to the guest as if the data is being provided from a file system on disk by emulating a file system and an underlying disk or LUN slice, thereby providing a virtualized volume to a non-virtualized client.

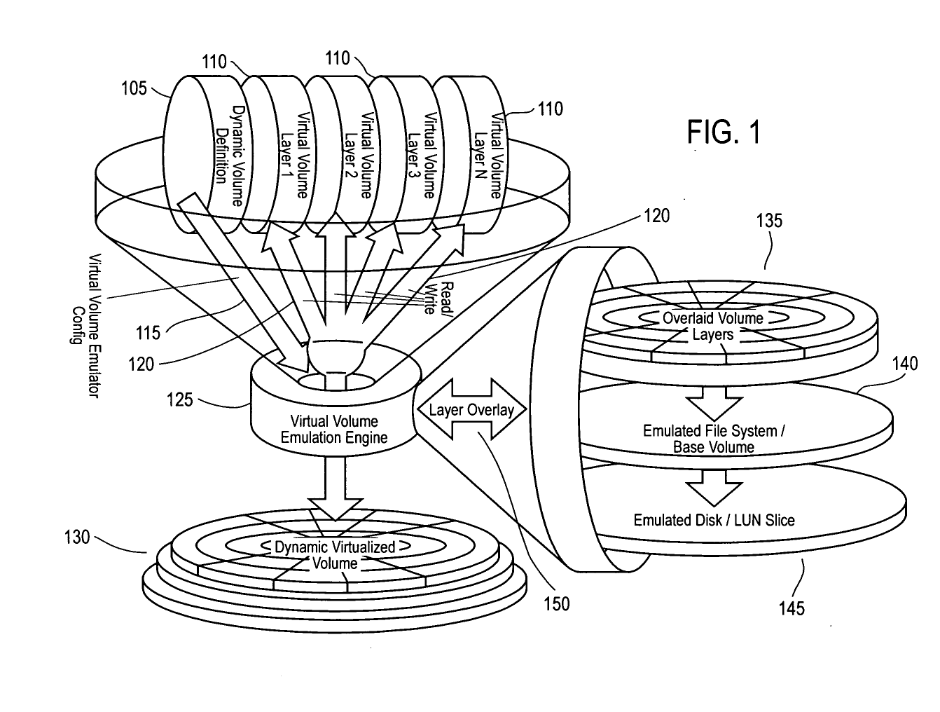

In one embodiment depicted in FIG. 1, the VEE may then be used to overlay data from multiple volume layers to provide an emulated file system based in actuality on an overlay of multiple actual volume layers.

In the figure, a dynamic volume definition 105 defines for the Virtual VEE 125 the actual mapping between the available volume layers 110, numbered 1, 2, 3, etc. through N, to the emulated virtual volume 130 provided to the client. The algorithms embodied in the VEE 125 in the embodiment determine how data from the volume layers 110 is overlaid, 135, to form the file system or base volume 140 that is then presented to the client on an emulate disk or LUN slice 145. The layer overlay process 150 is the mapping that occurs when a read or write request from the client to a file in the virtualized volume 130 has to be mapped to an actual read or write to an actual file in one of the volume layers 110.

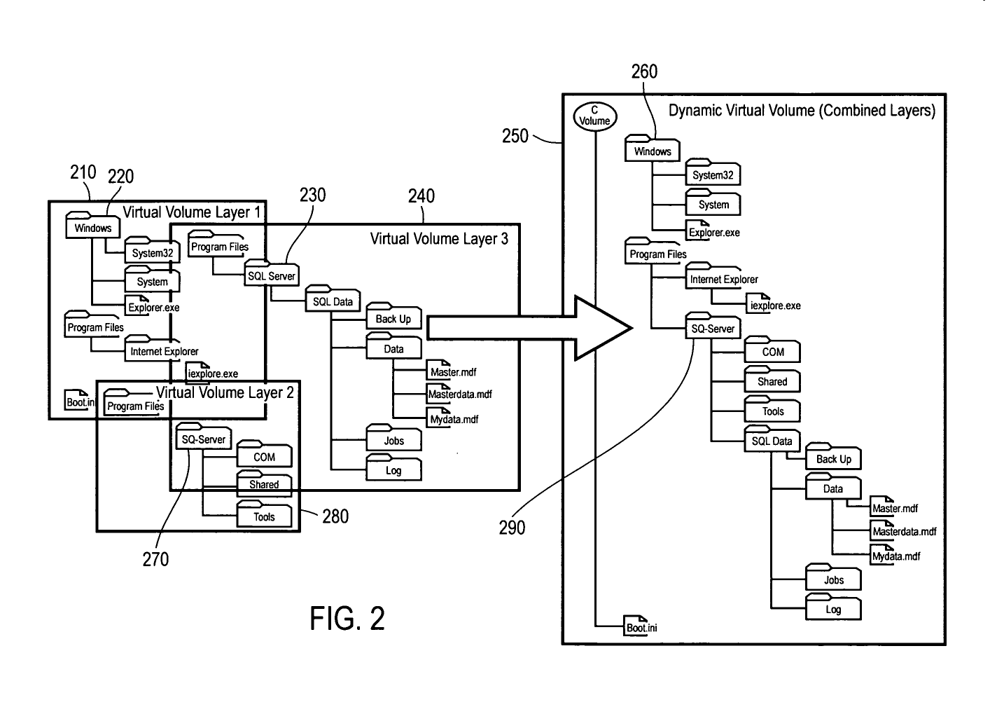

FIG. 2 depicts how from a user's perspective, the apparently visible file system on a virtual volume 250 is actually based on mappings to multiple layers 210, 240 and 280. For example the Windows directory 260 in the virtual volume 250 is mapped to the actual Windows directory 220 in Virtual Volume Layer 1, 210. However, the SQL server directory visible to the client at 290 may be mapped from either the version of the directory on Layer 2, 270, or layer 3, 230. In general, in this embodiment it is the task of the VEE to map accesses to files that exist on multiple layers to a single instance based on the writeability, overrideability, and level of the file and the layer on which the file exists. In the example of FIG. 2, the SQL sever directory on layer 2 is the version of the file being used by the client that accesses the dynamic virtual volume 250.

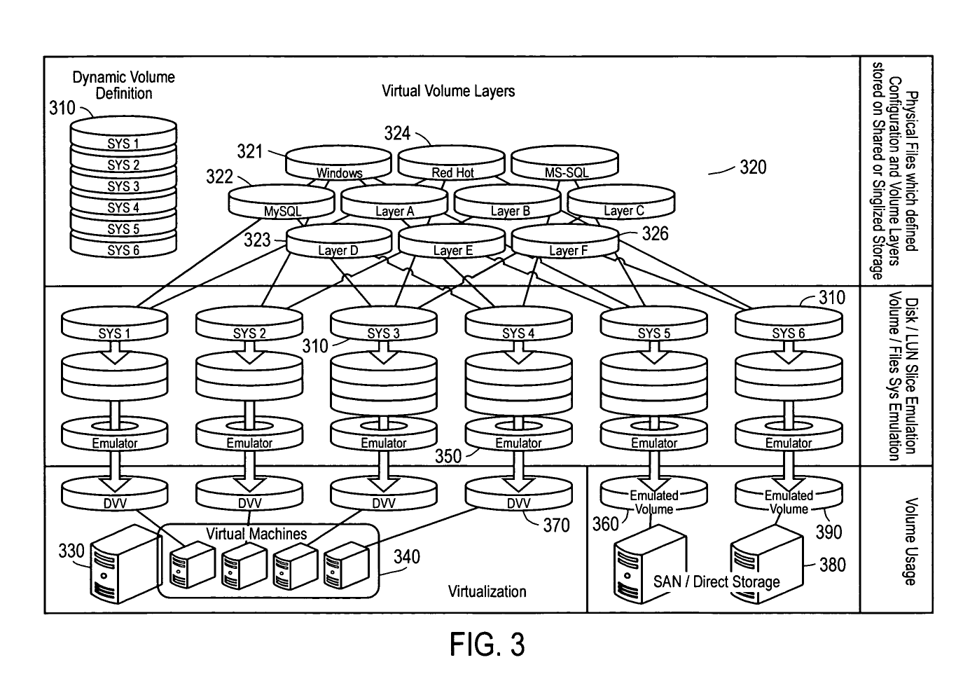

FIG. 3 depicts a system level view of dynamic virtual volumes for virtualzed systems and a similar view for emulated volumes for non-virtualized systems. In the figure, host 330 is used to provide multiple VMs 340, each of which may then have a virtualized dynamic volume, or DVV 370. Similarly servers or other devices 380 may have virtualized volumes provided via emulation as at 390. Each virtualized volume for the six systems shown, i.e. the four VMs 340 and the other two emulated volume clients 380, is defined by a dynamic volume definition (DVD) 310, labeled SYS1 through SYS6 in the figure. As will be further explained in the sequel, each DVD defines how the virtual volume presented to each system is configured based on the actual volumes, the Virtual Volume Layers 320. Thus for example, the overlay of a Windows layer 321, an MySQL Layer 322, and a data layer, Layer D, 323, form the overlay that is defined by DVD SYS 4 for the virtual volume 370. Similarly, the emulated virtual volume 390 may be composed of overlaid layers Red Hat Linux layer 324 and data layer Layer N 326 defined by the SYS 6 DVD.

Table 1 is an exemplary embodiment of a DVD. In Table 1, a <logicalvolume> definition defines a logical volume for a system, defining an NTFS filesystem within the <filesystem> definition, called “sqlserver001-C” on volume C: using <volumename> and <volume> definitions. The virtual volume layers that correspond to this logical volume are then defined by a series of <virtualvolumelayer> definitions.

Each virtual volume layer includes a layer name, an ordering to define a name, the priority of the layer, a read write status for the layer, and an overrideability status for the layer, specified by the <layername>, <layerorder>, <writeable> and <override> tags. In addition, a mapping to the actual file that is defines the layer itself is provided by the <filename> definition. A reference to the logical volume to which the layer is mapped is provided at <Volumelocation> and a maximum size is provided by a <maxsize> definition.

As may be seen from the table, three layers are defined in this embodiment, the first being an OS layer, the second an SQL server layer, and the third being a general purpose layer.

In particular, for example, layer 2 is named “Microsoft SQL 2005” and is no. 2 in the layer order. It is described as a Database layer, and mapped to an actual file located at SYS:/virtualdisk/SQL2005. The corresponding folder on the virtual disk is to C:\Program Files\Microsoft SQL Server. Its maximum size is set to 1500 Mb, and the layer is not writeable, and overrideable.

TABLE 1

<dynamicvolumeconfig>
<logicalvolume>
<filesystem>ntfs</filesystem>
<volumename>sqlserver001-c</volumename>
<volume>C:</volume>
<maxsize>10000mb</maxsize>
</logicalvolume>
<virtualvolumelayer>
<layername>Microsoft Windows 2003 SP2</layername>
<layerorder>1</layerorder>
<description>Operating System</description>
<filename>SYS:/virtualdisk/Windows2k3SP2.vv1</filename>
<Volumelocation>C:\windows</Volumelocation>
<maxsize>2500mb</maxsize>
<writeable>no</writeable>
<override>no</override>
</virtualvolumelayer>
<virtualvolumelayer>
<layername>Microsoft SQL 2005</layername>
<layerorder>2</layerorder>
<description>Database</description>
<filename>SYS:/virtualdisk/SQL2005.vv1</filename>
<Volumelocation>C:\Program Files\Microsoft SQL
Server</Volumelocation>
<maxsize>1500mb</maxsize>
<writeable>no</writeable>
<override>yes</override>
</virtualvolumelayer>
<virtualvolumelayer>
<layername>sqlserver001-c General</layername>
<layerorder>3</layerorder>
<description>Remaining C Volume</description>
<filename>SYS:/virtualdisk/sqlserver001-c.vv1</filename>
<Volumelocation>C:\</Volumelocation>
<maxsize>6000mb</maxsize>
<writeable>yes</writeable>
<override>no</override>
</virtualvolumelayer>
</dynamicvolumeconfig>

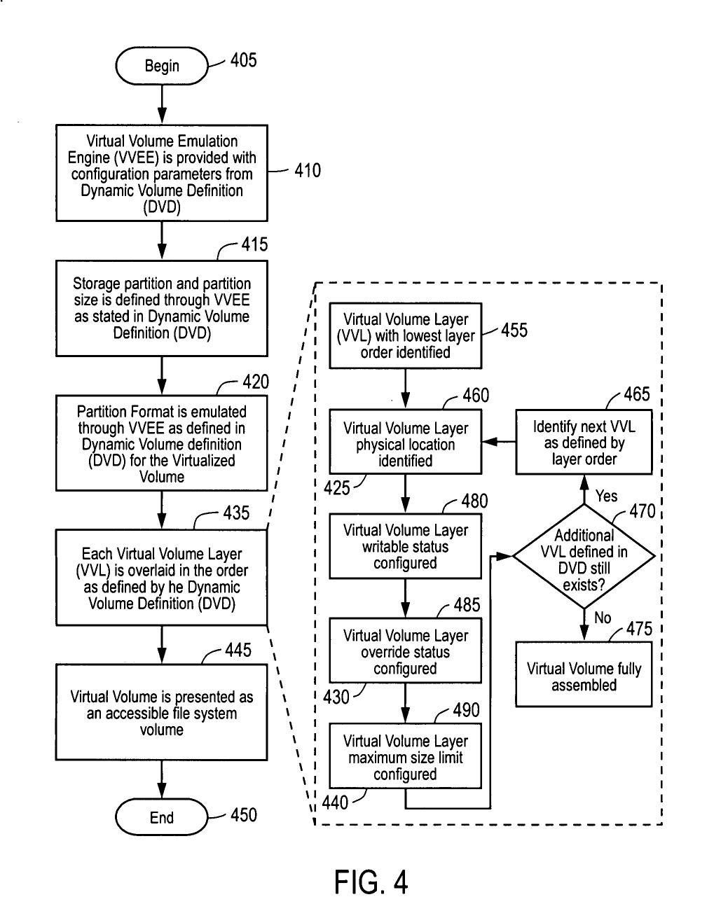

FIG. 4 is a flowchart of the construction of a dynamic virtualized or emulated virtual volume. At 410, the Virtual Volume Emulation Engine (VEE) is provided with configuration parameters from a Dynamic Volume Definition (DVD). At 415, storage partition and partition size is defined through the VVEE as stated in the DVD. At 420, a partition format is emulated through the VVEE as defined in DVD for the Virtualized Volume. Each Virtual Volume Layer (VVL) is overlaid in the order as defined by the DVD at 435. This element of the processing (435) may be further broken down as shown at 455-475.

At 455, the Virtual Volume Layer (VVL) with lowest layer order is identified, and its physical location identified, 460. Its writeable status is configured, 480 overrideability set, 485, and a maximum size limit specified, 490. If additional VVLs are defined for this DVD, 470, the next VVL is configured in layer order, 465, otherwise the Virtual Volume is fully assembled, 475, and processing resumes at 445 by presentation of the Virtual Volume as an accessible file system volume to the client via virtualization or emulation.

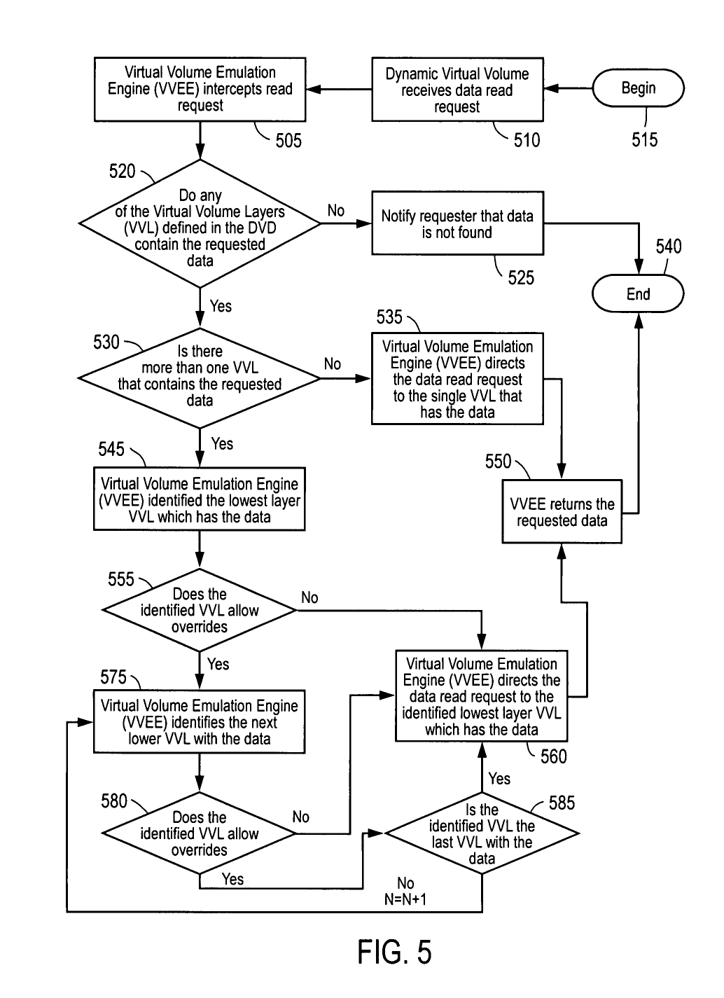

FIG. 5 begins at 515 and depicts the process of reading from a DVV. On receipt of a data read request 510, the VEE intercepts the request 505 and checks for the existence of the data, typically a file, on any of the VVLs in the DVD for the DVV. If no data is found, the requestor is notified, 525, and the read terminates, 540. Otherwise, the VEE checks if the data is present on more than one layer, 520. If not, the data present on a single layer is read from the layer on which it is found, 535 and returned, 550 and 540. If the data is present in possibly different versions on different layers, the VEE identifies the lowest layer on which the data is present, 545. Next VEE checks in a loop for the lowest VVL that allows overrides, loop at 555, 580, 585, 575. When the lowest VVL that allows overrides is found, either at 555 or 580, the VVL reads the data from the identified VVL 560 and returns it.

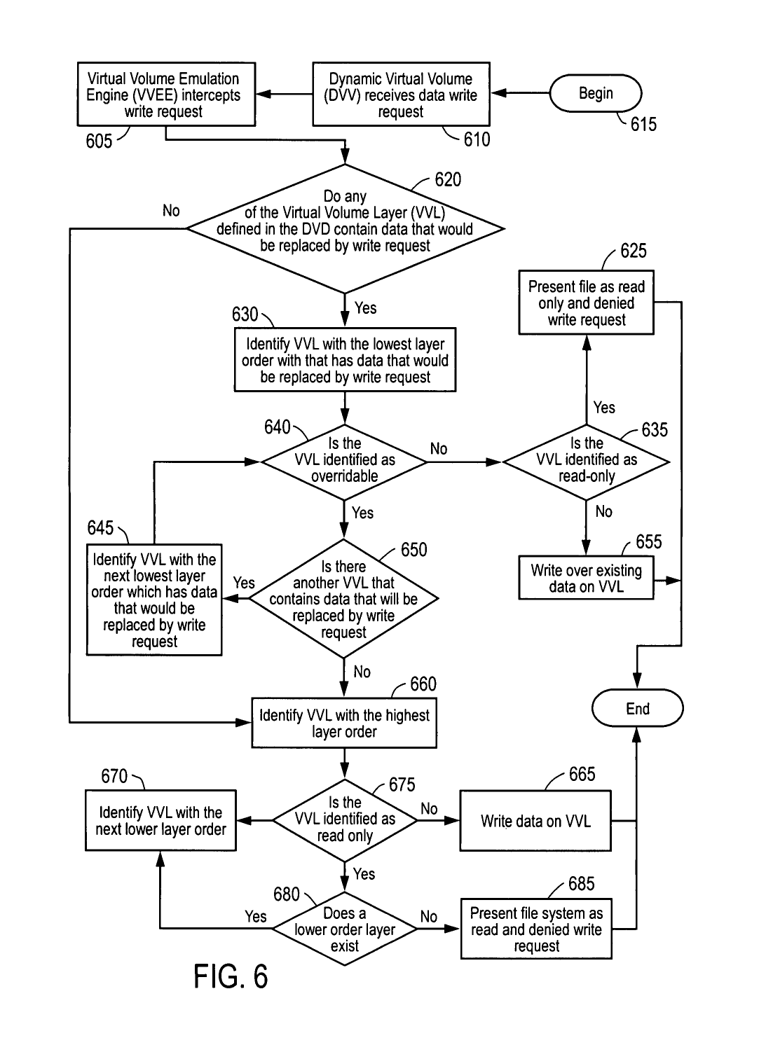

FIG. 6 begins at 615 to process a write request 610 received by a VEE at 605. If the data is not present on any VVL, 620, then the VEE identifies the VVL with highest layer order, 660, and enters a loop to find lowest VVL layer that is writeable, loop 675, 680, 670. If no such layer is found, the file system is read only and the request is denied, 685. If a layer is found that is writeable, the lowest such layer is written, 665.

If the data is present on a VVL, at 620, then the lowest layer order VVL with the data that would be replaced by the new data in the write request is identified, 630; and then the lowest non-overrideable, writeable layer with the data is found, 640, 650, 645 and the write processed as above. If last non-overrideable layer is read only, 635, the filesystem is presented as read only, otherwise, the existing data is overwritten, 655.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above are presented in terms of algorithms and symbolic representations of operations on file bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms file represented as physical quantities within the processor-based system's storage into other file similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. File representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of file representing the physical placement of various devices in the hardware model. In the case where conventional semiconductor fabrication techniques are used, file representing a hardware model may be the file specifying the presence or absence of various features on different mask layers for masks used to produce the integrated circuit. In any representation of the design, the file may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon file which when accessed by a machine may cause the machine to perform a process according to the claimed subject matter. The machine-readable medium may include, but is not limited to, floppy diskettes, optical disks, DVD-ROM disks, DVD-RAM disks, DVD-RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote file source to a requesting device by way of file signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below.

What is claimed is:

1. A method comprising:
providing a virtualized volume to a client and virtualized files on the virtualized volume by
emulating a disk;
emulating a file system;
storing an file corresponding to the each virtualized file on at least one of a plurality of volume layers.

2. The method of claim 1 further comprising:
translating an attempt by the client to access a virtualized file of the virtualized volume to an access to a file on a volume layer.

3. The method of claim 1 wherein each volume layer has one or more of:
access restrictions,
a priority and
an overrideability state.

4. The method of claim 3 wherein the translating is based at least in part on the type of access sought;
the state of replication of the file across layers; and
the access restrictions, priority and overrideabilty states of the layers on which versions of the file exists.

5. The method of claim 2 wherein the translating is based on a dynamic volume definition describing a mapping from the virtualized volume to the volume layers

6. The method of claim 2 wherein the dynamic volume definition defines at least a size, format, a priority, and an override status for the virtualized volume.

7. The method of claim 5 wherein a virtual volume emulator performs the translating,
the translating further comprising
locating all volume layers that contain the requested file;
if more than one volume layer contains the requested file and
if the access is a read request, selecting a version of the file from a volume layer based on overrideability and priority; or
if the access is a write request, selecting a version of the file from a volume layer based on writeability, overrideability and priority.

8. A machine readable medium having stored thereon file that when accessed by a machine causes the machine to perform a method, the comprising:
providing a virtualized volume to a client and virtualized files on the virtualized volume by
emulating a disk;
emulating a file system;
storing an file corresponding to the each virtualized file on at least one of a plurality of volume layers.
translating an attempt by the client to access a virtualized file of the virtualized volume to an access to a file on a volume layer, wherein each volume layer has one or more of:
access restrictions,
a priority and
an overrideability state; and
the translating is based at least in part on
the type of access sought;
the state of replication of the file across layers; and
the access restrictions, priority and overrideabilty states of the layers on which versions of the file exists.

9. A processor based system comprising:
A client executing on the processor based system;
a virtualized volume having stored thereon virtualized files;
and a virtual volume emulation unit to provide access for the client to the virtualized volume by
emulating a disk;
emulating a file system;
storing an file corresponding to the each virtualized file on at least one of a plurality of volume layers.

10. The processor based system of claim 9 wherein the virtual volume emulation unit (VVE) is further to:
translate an attempt by the client to access a virtualized file of the virtualized volume to an access to a file on a volume layer.

11. The processor based system of claim 9 wherein each volume layer has one or more of:
access restrictions,
a priority and
an overrideability state.

12. The processor based system of claim 11 wherein the VVE is to translate the attempt the access based at least in part on
the type of access sought;
the state of replication of the file across layers; and
the access restrictions, priority and overrideabilty states of the layers on which versions of the file exists.

13. The processor based system of claim 12 wherein the VVE is further to
locate all volume layers that contain the requested file; and
if more than one volume layer contains the requested file,
and if the access is a read request, selecting a version of the file from a volume layer based on overrideability and priority;
or if the access is a write request, selecting a version of the file from a volume layer based on writeability, overrideability and priority.
